(19) United States
(12) Patent Application Publication
(10) Pub. No.: US 2015/0145675 A1
(43) Pub. Date: May 28, 2015

(54) PROGRAMMABLE WIRELESS ALARM DEVICE AND THE ALARM SYSTEM HAVING THE SAME

(71) Applicant: EVERDAY TECHOLOGY CO., LTD., Yilan County (TW)

(72) Inventor: Shih-Hsiung HSIEH, Yilan County (TW)

(21) Appl. No.: 14/534,885

(22) Filed: Nov. 6, 2014

(30) Foreign Application Priority Data
Nov. 27, 2013 (TW) 102143281

(51) Int. Cl. G08B 25/10

(52) U.S. Cl. CPC G08B 25/10
USPC 340/539.16

(57) ABSTRACT

The present disclosure provides a programmable wireless alarm device comprising a detecting and input unit, a central processing unit, an output unit, an indicating unit and a wireless transmission unit. The central processing unit receives a detecting signal and an input signal from the detecting and input unit, and generates an alarm signal according to at least one of the detecting signal, the input signal and a control signal. The output unit receives the alarm signal. The indicating unit generates an indicating signal corresponding to the alarm signal according to the driving signal of the output unit. The wireless transmission unit has an UART interface for receiving the control signal which is used for redefining the indicating signal corresponding to the alarm signal by the central processing unit. Accordingly, the programmable wireless alarm device has more flexible functions, and the design and manufacturing cost could be saved.

### BACKGROUND OF THE INVENTION

1. Field of the Invention

The instant disclosure relates to an alarm device; in particular, to a programmable wireless alarm device and an alarm system having the same.

2. Description of Related Art

The conventional alarm devices, such as the smoke detecting devices, the temperature detecting device, the gas detecting devices, utilize the detecting element of the alarm device to detect the environmental status and utilize speaker elements or light emitting elements to generate sound or light representing the alarm signals. Further, the sound or light produced by the alarm devices could indicate the alarm status, a low-power status or a working abnormal state. And, not only the alarm devices could produce alarm signals, but also the existed alarm devices may transmit the alarm signals to exterior device(s) via wire means or wireless means.

Please refer to FIG. 1 showing a circuit diagram of a conventional wireless alarm device. The conventional wireless alarm device 1 comprises a power supply unit 11, a detecting and input unit 12, a central processing unit 13, an output unit 14 and an indicating unit 15. The detecting and input unit 12 comprises detecting elements 121, 122 and an input element (the button 123 shown in FIG. 1). The central processing unit 13 comprises a microprocessor 131, a signal converter 132, an exterior interrupter 133 and a memory 134. The output unit 14 comprises a driving unit 141 and a wireless module 142. The indicating unit 15 may comprise a buzzer 151 and a LED 152 for example. The wireless module 142 is wirelessly linked to an exterior device 3, in which the exterior device 3 may be a host of an alarm system for example. The wireless module 142 (which may be a radio frequency (RF) board) could be installed into the wireless alarm device 1, thus the wireless alarm device 1 has the function of wirelessly transmitting the alarm signal. Additionally, the button 124 and the LED 153 are the additional functions according to the design requirement which would be described in the follows.

Regarding the design of the conventional wireless alarm device 1, the functions are predetermined and not changeable. For example, the quantity of the input keys (or buttons), the quantity and the display manner of the LEDs 152, the beep manner of the buzzer 151, firmware setup and the manner of wireless transmission are not changeable after the manufacturing process has been completed. Thus, if the user wants to change or add any indicating manner of the alarm device, the user will have to redesign the alarm device. For example, when the user wants to add a function (e.g. adding a doorbell function), the user have to add the button 124, to change the programming of the firmware, to add another LED 153 (because the original LED 152 is designed as dedicated for indicating alarm), and to change the driving circuit. Further, the wireless module 14 of the conventional alarm device 1 only outputs the alarm signal, and the wireless module 14 could not provide other functions. Meanwhile, the body or casing of the alarm device may also be redesigned accordingly. As a result, more time and related cost would be invested to the manufacturing process.

### SUMMARY OF THE INVENTION

The object of the instant disclosure is to offer a programmable wireless alarm device and an alarm system having the same, in which the alarm signal (and the indicating signal) generated by the programmable wireless alarm device could be redefined according to the control signal received by the programmable wireless alarm device.

In order to achieve the aforementioned objects, according to an embodiment of the instant disclosure, a programmable wireless alarm device is provided. The programmable wireless alarm device comprises a detecting and input unit, a central processing unit, an input unit, an indicating unit and a wireless transmission unit. The detecting and input unit has at least a detecting element and at least an input element. The input element is utilized for generating a detecting signal. The input element is utilized for generating an input signal. The central processing unit is coupled to the detecting and input unit. The central processing unit receives the detecting signal and the input signal from the detecting and input unit. The central processing unit generates an alarm signal according to at least one of the detecting signal, the input signal and a control signal. The output unit is coupled to the central processing unit. The output unit receives the alarm signal and converts the alarm signal to a driving signal. The indicating unit is coupled to the output unit. The indicating unit generates an indicating signal corresponding to the alarm signal according to the driving signal of the output unit. The wireless transmission unit has a universal asynchronous receiver/transmitter (UART) interface and a wireless module. The UART interface is coupled to the central processing unit. The wireless module is coupled to the UART interface. The UART interface receives the control signal from the wireless module. The control signal is utilized for redefining the indicating signal corresponding to the alarm signal by the central processing unit.

In order to achieve the aforementioned objects, according to an embodiment of the instant disclosure, an alarm system is provided. The alarm system comprises a host and at least a programmable wireless alarm device. The host generates a control signal. The programmable wireless alarm device wireless receives the control signal from the host. The programmable wireless alarm device comprises a detecting and input unit, a central processing unit, an input unit, an indicating unit and a wireless transmission unit. The detecting and input unit has at least a detecting element and at least an input element. The input element is utilized for generating a detecting signal. The input element is utilized for generating an input signal. The central processing unit is coupled to the detecting and input unit. The central processing unit receives the detecting signal and the input signal from the detecting and input unit. The central processing unit generates an alarm signal according to at least one of the detecting signal, the input signal and a control signal. The output unit is coupled to the central processing unit. The output unit receives the alarm signal and converts the alarm signal to a driving signal. The indicating unit is coupled to the output unit. The indicating unit generates an indicating signal corresponding to the alarm signal according to the driving signal of the output unit. The wireless transmission unit has a universal asynchronous receiver/transmitter (UART) interface and a wireless module. The UART interface is coupled to the central processing unit. The wireless module is coupled to the UART interface. The UART interface receives the control signal from the wireless module. The control signal is utilized for redefining the indicating signal corresponding to the alarm signal by the central processing unit.

In summary, the provided programmable wireless alarm device and the alarm system having the same could utilize the UART interface and redefine the alarm signal (and the indicating signal) of the programmable wireless alarm device according to the control signal. Therefore, the host communicated with the programmable wireless alarm device could control the alarm signal (and the indicating signal) for performing more flexible functions, and the design of the alarm device could be simplified in order to save the design effort and the related cost of manufacturing.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a circuit diagram of a conventional wireless alarm device;

FIG. 2 shows a schematic diagram of an alarm system according to an embodiment of the instant disclosure; and

FIG. 3 shows a block diagram of a programmable wireless alarm device according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

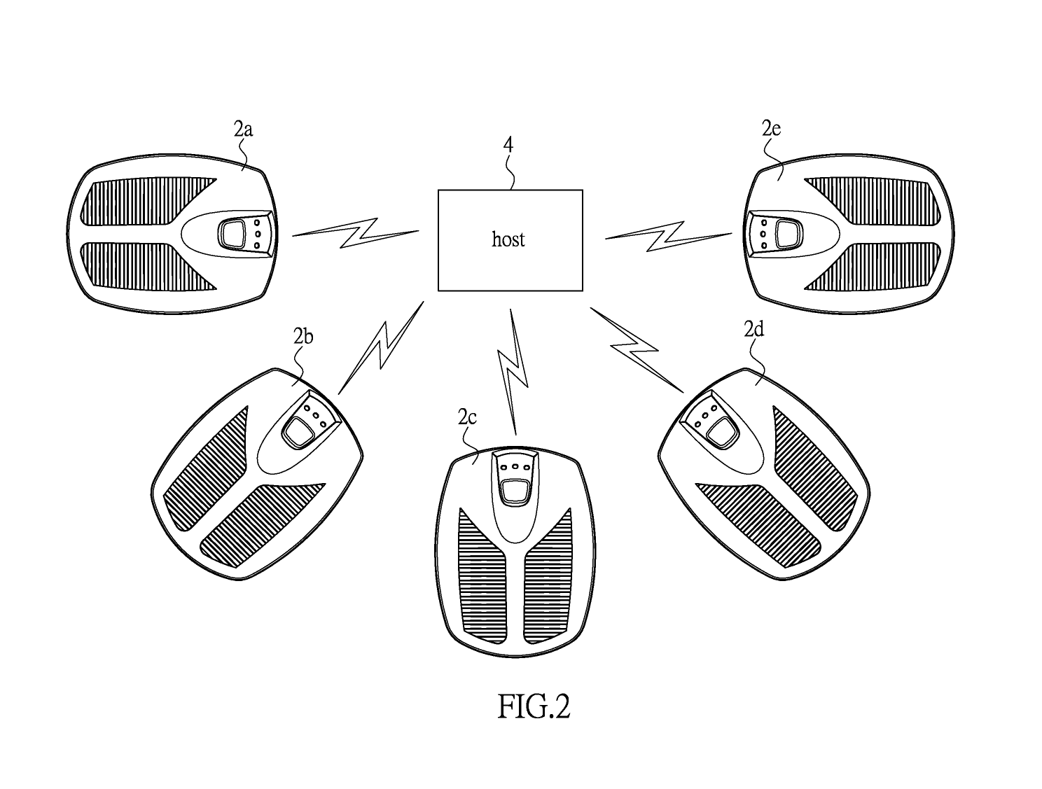

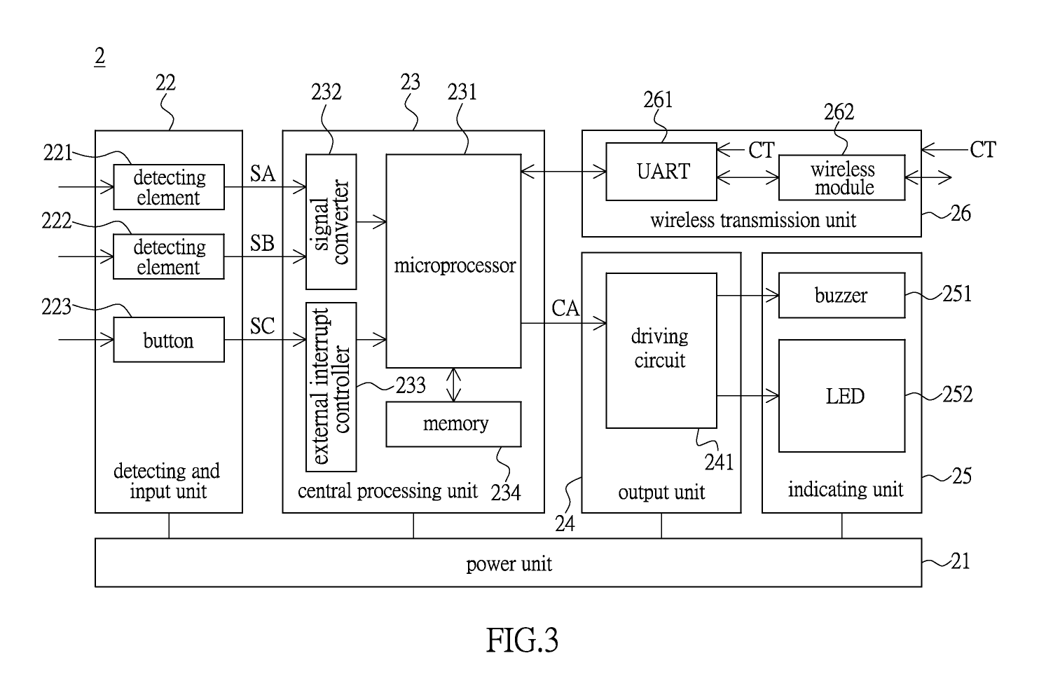

Please refer to FIG. 2 showing a schematic diagram of an alarm system according to an embodiment of the instant disclosure. The alarm system comprises a host 4 and at least a programmable wireless alarm device, e.g. the programmable wireless alarm devices 2a, 2b, 2c, 2d and 2e as shown in FIG. 2. The host 4 generates a control signal (CT which would be described in FIG. 3). The part identical to the conventional alarm system is that the host 4 could wirelessly receive the alarm signal (CA which would be described in FIG. 3) from the programmable wireless alarm devices 2a, 2b, 2c, 2d and 2e. However, the programmable wireless alarm devices 2a, 2b, 2c, 2d and 2e of the instant disclosure could further receive the control signal (CT) from the host 4. The control signal (CT) not only controls the alarm signals (CA) generated by the programmable wireless alarm devices 2a, 2b, 2c, 2d and 2e, but also redefine the operation manners of the indicating units on the programmable wireless alarm devices 2a, 2b, 2c, 2d and 2e. Details would be described in the following embodiments.

Please refer to FIG. 2 in conjunction with FIG. 3, FIG. 3 shows a block diagram of a programmable wireless alarm device according to an embodiment of the instant disclosure. The programmable wireless alarm device 2 is one of the programmable wireless alarm devices 2a, 2b, 2c, 2d and 2e. The programmable wireless alarm device 2 comprises a power supply unit 21, a detecting and input unit 22, a central processing unit 23, an output unit 24, an indicating unit 25 and a wireless transmission unit 26. It is worth mentioning that the aforementioned related circuits of the programmable wireless alarm device 2 could be configured into a body (not shown in the figure), thus the programmable wireless alarm device 2 could be easily installed to any place needing detecting or indicating alarm. The programmable wireless alarm device 2 may be a smoke alarm, a temperature detector or a gas alarm, for example, a carbon monoxide (CO) alarm, a carbon dioxide (CO2) alarm or other specific gas alarm. The programmable wireless alarm device 2 could be applied to firefighting, environmental safety monitoring, or security monitoring . . . etc. This instant disclosure does not restrict the purpose, the application and the type of the alarm of the programmable wireless alarm device 2.

The power supply unit 21 is coupled to the detecting and input unit 22, the central processing unit 23, the output unit 24, the indicating unit 25 and the wireless transmission unit 26. The central processing unit 23 is coupled to the detecting and input unit 22. The output unit 24 is coupled to the central processing unit 23. The wireless transmission unit 26 is coupled to the central processing unit 23. The indicating unit 25 is coupled to the output unit 24.

The power supply unit 21 is utilized for supplying power to the detecting and input unit 22, the central processing unit 23, the output unit 24, the indicating unit 25 and the wireless transmission unit 26. Depending on the type of the power source, the power supply unit 21 may comprises a battery or a transformer or both. The power supply unit 21 may be coupled to exterior power source (e.g. 110V AC of the city grid), or may utilize the battery of itself to supply power to the circuit.

The detecting and input unit 22 has at least a detecting element and at least an input element (e.g. the detecting elements 221, 222 and a button 223 shown in FIG. 3). The detecting elements 221, 222 are respectively used for generating detecting signals SA and SB. The detecting elements 221, 222 may be smoke detecting elements, temperature detecting elements or gas detecting elements or other types of detecting elements for detecting environment status, and the type of the detecting element of the instant disclosure is not restricted thereto. The button 223 is for generating an input signal SC. The button 223 may be a dip switch for example, but the instant disclosure is not so restricted.

The central processing unit 23 receives the detecting signals SA and SB from the detecting and input unit 22 and receives the input signal SC. The central processing unit 23 generates the alarm signal CA according to at least one of the detecting signals SA and SB, the input signal SC and the control signal CT. In this embodiment, the central processing unit 23 comprises a microprocessor 231, a signal converter 232, an exterior interrupter 223, and a memory 234. The signal converter 232 converts the detecting signal SA of the detecting unit 221 for transmitting to the microprocessor 231. The signal converter 232 also converts the detecting signal SB of the detecting element 222 for transmitting to the microprocessor 231. The exterior interrupter 233 generates an interrupt service routine (ISR) according the input signal SC generated through manually operation made by the user. The exterior interrupter 223 stores the ISR to the memory 234. The ISR stored in the memory 234 is accessed by the microprocessor 231 for processing. Additionally, the central processing unit 23 also transmits the alarm signal CA to the host 4 through the wireless transmitting unit 26.

The output unit 24 receives the alarm signal CA and converts the alarm signal CA to a driving signal. The output unit 24 usually comprises a driving unit 241 and related output interface (not shown in the figure). Depending on the type of the indicating element of the indicating unit 25, the driving circuit 241 or related output interface could be a buzzer driving circuit, or a LED driving circuit for example. Because the driving circuit 241 is for controlling the operation of the indicating element of the indicating unit 25, the design of the driving circuit 241 should meet the requirement of the indicating element of the indicating unit 25.

The indicating unit 25 generates an indicating signal (e.g. sound or light . . . etc.) corresponding to the alarm signal CA according to the driving signal of the output unit 24. Therefore, the users may learn of the happened alarm condition through auditory sense or sense of sight in order to conduct response actions, such as firefighting, taking refuge, ensuring safety . . . etc. The indicating unit 25 comprises at least one of a speaker element and a light emitting element. The speaker element may be a buzzer 251 disclosed in FIG. 3. The light emitting element may be a LED or two LEDs. The indicating unit 25 may be utilized for performing sound or light in order to let the users be aware of the alarm. In other words, the indicating signal generated by the indicating unit 25 makes the speaker element produce sound or makes the light emitting element emit light or blink.

The buzzer 251 may generate sounds with high or low frequencies. The duration period of the sounds, the interrupt of the sounds, or the time interval of the sounds could also be controlled by the driving circuit 241. The buzzer 251 may be installed into the programmable wireless alarm device 2, and usually the design (including the quantity of the buzzers and the specification) of the buzzer 251 is predefined (or predetermined) during design process of the programmable wireless alarm device 2.

The central processing unit 23 may operates in an alarm mode according to the detecting signals SA, SB and the input signal SC. The alarm mode is usually predefined by the manufacturer and not changeable. For example, the generated alarm signal CA causing by the detecting signal SA may make the buzzer 251 produce a long beep without interruption, and the LED 252 may emit light continuously. The generated alarm signal CA causing by the detecting signal SB may make the buzzer 251 produce a long beep following with a short beep, and the LED 252 may blink repeatedly. The input signal SC provided by the button 223 may also cause the microprocessor 231 to generate another alarm signal CA different from the two aforementioned alarm signals CA, for example, causing the buzzer 251 to produce one long beep and two short beeps, and causing the LED 252 to blink in one long time interval and then in two short time intervals. Alternatively, if the LED 252 is replaced by more than one LED, e.g. two different color LEDs, the LEDs with different color could be controlled to emit light or blink as needed. It is worth mentioning that above alarm indications could be predetermined in the design and manufacturing process of the programmable wireless alarm device 2.

The wireless transmission unit 26 has a universal asynchronous receiver/transmitter (UART) interface 261 and a wireless module 262. The UART interface 261 is coupled to the microprocessor 231 of the central processing unit 23. The wireless module 262 is coupled to the UART interface 261. The UART interface 261 receives the control signal CT from the wireless module 262. The control signal CT may be generated by the wireless module 262 itself or wireless received by the wireless module 262. The control signal CT is utilized for redefining the indicating signal corresponding to the alarm signal by the central processing unit 23. Specifically, according to the content of the encoded signal of the control signal CT the UART interface 261 may provide converted encoded signal to the microprocessor 231, and the microprocessor 231 could redefine the alarm signal CA according to the content of the converted encoded signal.

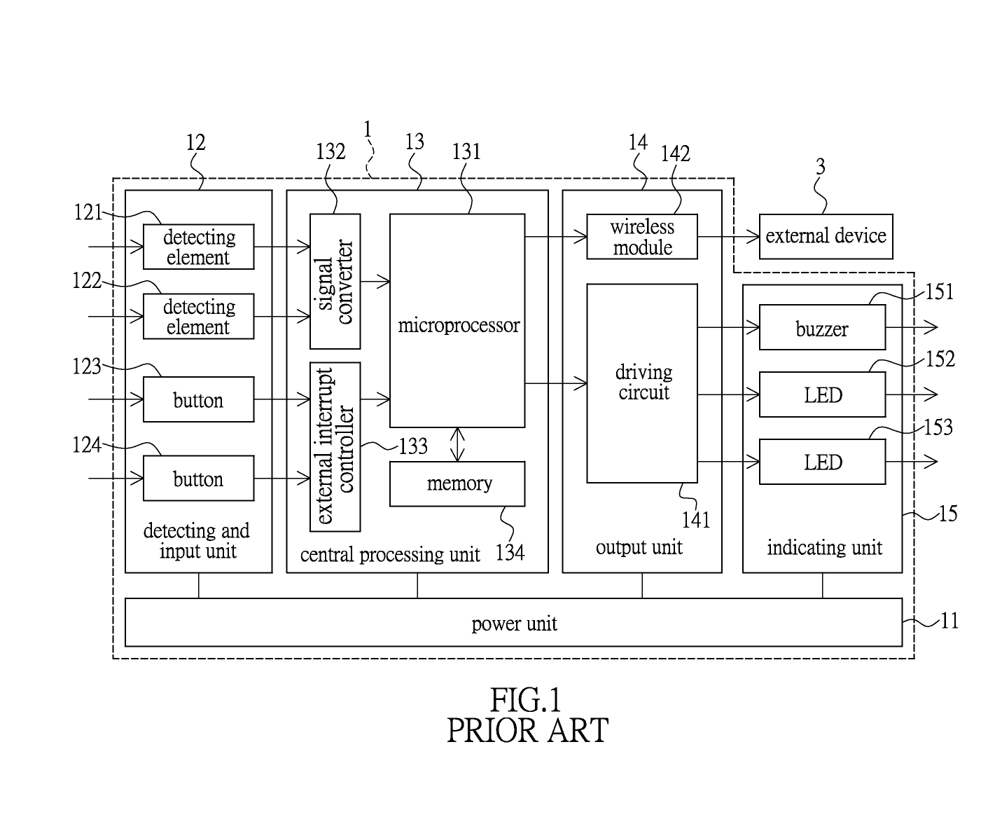

It is worth mentioning that, the conventional alarm device (e.g. the wireless alarm device 1 shown in FIG. 1) does not have the UART interface, and the alarm function or indication manner would not be changeable due to the original design of the manufacturer. On the contrary, the programmable wireless alarm device 2 of the instant disclosure could utilize the microprocessor 231 and the UART interface 261 of the wireless transmission unit 26 to redefine the sound generated by the buzzer 251 according to the control signal CT. Similarly, although the quantity and the type of the light emitting elements is predetermined in the design of the programmable wireless alarm device 2, the blink manner of the light emitting element(s) or the light (or blink) sequence of the light emitting elements could be redefined by the microprocessor 231 cooperating with the UART interface 261 of the wireless transmission unit 26 according to the control signal CT. In other words, in order to make the buzzer 251 and the LED(s) 252 of the indicating unit 25 indicate different indicating alarm, the UART interface 261 is utilized to convert the received control signal CT to the microprocessor 231 of the central processing unit 23 for programming content of the alarm signal CA. Therefore, different user could use the indicating unit 25 of the programmable wireless alarm device 2 to generate the alarm indication as required.

Please refer to FIG. 1 in conjunction with FIG. 3, the wireless module 14 of the conventional wireless alarm device 1 could only output the alarm signal, and no any further function is provided. The wireless module of the programmable wireless alarm device 2 of this embodiment has both of the input function and the output function. The firmware of the conventional wireless alarm device 1 is not changeable. But, the programmable wireless alarm device 2 of this embodiment could receive the control signal for controlling exterior interrupt and the output content. In other words, the central processing unit 23 operates in a programmable mode according to the control signal CA, wherein the indicating signal corresponding to the alarm signal CA is changed according to the control signal CT. For example, the central processing unit 23 may redefine the sound manner of the speaker element (e.g. buzzer 251) or the light emitting status of the light emitting element (e.g. the LED 252). Further, the control signal CT is also utilized by the central processing unit 23 to control the exterior interrupt of the input element (e.g. button 223) of the detecting and input unit 22.

In one embodiment of the instant disclosure, when the user wants to utilize the programmable wireless alarm device 2 as a doorbell, the user only needs to couple the doorbell switching signal with the button 223 of the programmable wireless alarm device 2, then utilizes a host to configure the beep manner of the buzzer 251 by communicating with the central processing unit 223 through the wireless module 262 (which is usually a module of a RF board). Thus, it is not need to set up additional doorbell while utilizing the programmable wireless alarm device 2 and the manufacturer of the alarm device does not need to change the design of the alarm device for any specific user. Therefore, the related cost of design changes could be saved. Additionally, in another embodiment of the instant disclosure, the buzzer 251 or the LED 252 of the programmable wireless alarm device 2 could be utilized to indicate the transmission status of the wireless module 262 (e.g. RF board). The wireless module 262 itself may generate the control signal CT, and then the wireless module 262 may control the buzzer 251 or the LED 252 of the programmable wireless alarm device 2 through the UART interface 261. According to the signal transmission status of the wireless module 262, the buzzer 251 may generate different sounds, or the LED(s) 252 may display different light. Accordingly, the manufacturer of the wireless module 262 does not need to design an additional status indicator (e.g. a buzzer or a LED). That is, the cost could be saved regarding to both of the alarm device or the wireless module.

In another embodiment of the instant disclosure, when the user wants to make the host 4 control the buzzer 251 or the LED(s) 252 of the programmable wireless alarm device 2. The host 4 may be utilized to wirelessly transmit the control signal CT, and the microprocessor 231 of the central processing unit 23 could redefines the generated sound of the buzzer 251 or the light manner of the LED(s) 252 according to the control signal CT converted by the UART interface 261. Thus, the manager of the host 4 or the manufacturer only have to design the corresponding control signal CT comply with the communication protocol of the UART interface 261, in order to utilize the central processing unit 23 to conduct the programmable function process about the operation of the buzzer 251 or the LED(s) 252. For example, the programmable wireless alarm device 2 could control the LED(s) 252 to light or blink in the redefined light emitting status according to the wirelessly received control signal CT.

In another embodiment of the instant disclosure, the programmable wireless alarm device 2 could be utilized as a district alarm bell, for replacing the conventional instrument of the regional alarm. Conventionally, the burglar alarm or firefighting system could generate alarms by utilizing a plurality of alarm devices in each floor (or district); in which each alarm device could only detect the environmental status around itself for generating individual alarm. For example, when each floor has furnished with a plurality of alarm devices, each floor usually needs a district alarm instrument for integrating each alarm on each floor or transmitting the alarm to other floors, in which the district alarm instrument is connected to all alarm devices in the corresponding floor. In order to make the user acquire the alarms of other floors, each district alarm instrument on each floor has to be coupled to each other for establishing a system. Thus, it needs more cost to implement the alarm system while utilizing the conventional district alarm instruments. On the contrary, the programmable wireless alarm device 2 described in FIG. 3 could directly transmit the alarm signal to the host 4, and the programmable wireless alarm device 2 could change the indicating manner (sound or light status) according to the control signal CT from the host 4. The programmable wireless alarm device 2 may generates the alarm signal (and the indicating signal) according to the controlling of the host 4. For example, when one of the programmable wireless alarm devices 2 on the first floor generates the alarm signal and transmits the alarm signal to the host 4, the host 4 may also control other programmable wireless alarm devices 2 on other floors to produce the indicating signal related to the alarm. For example, the host 4 may set the indicating manner (sound or lighting status) of the indicating signal of other floors' programmable wireless alarm devices 2 in order to make the programmable wireless alarm devices 2 of other floors generate the corresponding alarm signal (or indicating signal) about the alarm of the first floor. Accordingly, users on other floors could acquire the alarm of the first floor. As mentioned above, the building administrator or the owner of the house could acquire the alarm of other district at the neighbor of any alarm device on any floor. It can be seen that the programmable wireless alarm device 2 could improve the flexible of the system design and reduce the implementation costs of the alarm system.

According to above descriptions, the provided programmable wireless alarm device and the alarm system having the same could utilize the UART interface and redefine the alarm signal (and the indicating signal) of the programmable wireless alarm device according to the control signal. The redefined indicating signal may be the redefined sound signal or light signal, for example times of the sounds, the time length of the sound or the frequency of the sound of the speaker unit (e.g. buzzer), times of light, blink sequence, or blink period of the light emitting elements (e.g. LEDs). The programmable wireless alarm device provides the capability of shared button(s), speaker element(s) and light emitting element(s), and the programming of the firmware is more flexible, therefore the related cost of manufacturing could be saved and the users could utilize the detecting unit of the alarm device with their own ideas, thus a win-win outcome could be made. Therefore, the host communicated with the programmable wireless alarm device could control the alarm signal (and the indicating signal) for performing more flexible functions, and the design of the alarm device could be simplified in order to save the design effort and the related cost of manufacturing.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A programmable wireless alarm device, comprising:
a detecting and input unit, having at least a detecting element and at least an input element, the input element utilized for generating a detecting signal, the input element utilized for generating an input signal;
a central processing unit, coupled to the detecting and input unit, receiving the detecting signal and the input signal from the detecting and input unit, the central processing unit generating an alarm signal according to at least one of the detecting signal, the input signal and a control signal;
an output unit, coupled to the central processing unit, receiving the alarm signal, converting the alarm signal to a driving signal;
an indicating unit, coupled to the output unit, generating an indicating signal corresponding to the alarm signal according to the driving signal of the output unit; and
a wireless transmission unit, having a universal asynchronous receiver/transmitter (UART) interface and a wireless module, the UART interface coupled to the central processing unit, the wireless module coupled to the UART interface, the UART interface receiving the control signal from the wireless module, the control signal utilized for redefining the indicating signal corresponding to the alarm signal by the central processing unit.

2. The programmable wireless alarm device according to claim 1, wherein the UART interface wireless receives the control signal through the wireless module.

3. The programmable wireless alarm device according to claim 1, wherein the indicating unit comprises at least one of a speaker element and a light emitting element, the indicating signal generated by the indicating unit makes the speaker element produce sound or makes the light emitting element emit light or blink.

4. The programmable wireless alarm device according to claim 1, wherein the central processing unit operates in an alarm mode according to the detecting signal and the input signal, the central processing unit operates in a programmable mode according to the control signal, wherein the indicating signal corresponding to the alarm signal is changed according to the control signal when the central processing unit operates in the programmable mode.

5. The programmable wireless alarm device according to claim 2, wherein the central processing unit operates in an alarm mode according to the detecting signal and the input signal, the central processing unit operates in a programmable mode according to the control signal, wherein the indicating signal corresponding to the alarm signal is changed according to the control signal when the central processing unit operates in the programmable mode.

6. The programmable wireless alarm device according to claim 3, wherein the central processing unit operates in an alarm mode according to the detecting signal and the input signal, the central processing unit operates in a programmable mode according to the control signal, wherein the central processing redefines the sound produced by the speaker element or the light emitting status of the light emitting element according to the control signal when the central processing unit operates in the programmable mode.

7. The programmable wireless alarm device according to claim 1, wherein the control signal is utilized for the central processing unit controlling the external interrupt of the input element of the detecting and input unit.

8. The programmable wireless alarm device according to claim 1, wherein the detecting element is a smoke detecting element, a temperature detecting element or a gas detecting element.

9. The programmable wireless alarm device according to claim 1, further comprising:
a power supply unit, coupled to the detecting and input unit, the central processing unit, the output unit, the indicating unit and the wireless transmission unit, supplying power to the detecting and input unit, the central processing unit, the output unit, the indicating unit and the wireless transmission unit.

10. An alarm system, comprising:
a host, generating a control signal; and
at least a programmable wireless alarm device, wireless receiving the control signal from the host, comprising:
a detecting and input unit, having at least a detecting element and at least an input element, the input element utilized for generating a detecting signal, the input element utilized for generating an input signal;
a central processing unit, coupled to the detecting and input unit, receiving the detecting signal and the input signal from the detecting and input unit, the central processing unit generating an alarm signal according to at least one of the detecting signal, the input signal and a control signal;
an output unit, coupled to the central processing unit, receiving the alarm signal, converting the alarm signal to a driving signal;
an indicating unit, coupled to the output unit, generating an indicating signal corresponding to the alarm signal according to the driving signal of the output unit; and
a wireless transmission unit, having a universal asynchronous receiver/transmitter (UART) interface and a wireless module, the UART interface coupled to the central processing unit, the wireless module coupled to the UART interface, the UART interface receiving the control signal from the wireless module, the control signal utilized for redefining the indicating signal corresponding to the alarm signal by the central processing unit.

11. The alarm system according to claim 10, wherein the UART interface wireless receives the control signal through the wireless module.

12. The alarm system according to claim 10, wherein the indicating unit comprises at least one of a speaker element and a light emitting element, the indicating signal generated by the indicating unit makes the speaker element produce sound or makes the light emitting element emit light or blink.

13. The alarm system according to claim 10, wherein the central processing unit operates in an alarm mode according to the detecting signal and the input signal, the central processing unit operates in a programmable mode according to the control signal, wherein the indicating signal corresponding to the alarm signal is changed according to the control signal when the central processing unit operates in the programmable mode.

14. The alarm system according to claim 11, wherein the central processing unit operates in an alarm mode according to the detecting signal and the input signal, the central processing unit operates in a programmable mode according to the control signal, wherein the indicating signal corresponding to the alarm signal is changed according to the control signal when the central processing unit operates in the programmable mode.

15. The alarm system according to claim 12, wherein the central processing unit operates in an alarm mode according to the detecting signal and the input signal, the central processing unit operates in a programmable mode according to the control signal, wherein the central processing redefines the sound produced by the speaker element or the light emitting status of the light emitting element according to the control signal when the central processing unit operates in the programmable mode.

16. The alarm system according to claim 10, wherein the control signal is utilized for the central processing unit controlling the external interrupt of the input element of the detecting and input unit.

17. The alarm system according to claim 10, wherein the detecting element is a smoke detecting element, a temperature detecting element or a gas detecting element.

18. The alarm system according to claim 10, further comprising:
a power supply unit, coupled to the detecting and input unit, the central processing unit, the output unit, the indicating unit and the wireless transmission unit, supplying power to the detecting and input unit, the central processing unit, the output unit, the indicating unit and the wireless transmission unit.
